(19) United States
(12) Patent Application Publication
(10) Pub. No.: US 2010/0072218 A1
(43) Pub. Date: Mar. 25, 2010

(54) DISPLAY PACKAGE WITH INTEGRAL CLOSURE AND METHOD OF USE

(75) Inventors: Marc R. Meyer, Grand Rapids, MI (US); David H. Bult, Jenison, MI (US); Timothy J. Riegling, Grand Rapids, MI (US); Andrew J. Blackmore, Belmont, MI (US)

Correspondence Address: WARNER, NORCROSS & JUDD;IN RE: ALTICOR INC., INTELLECTUAL PROPERTY GROUP, 111 LYON STREET, N. W. STE 900, GRAND RAPIDS, MI, 49503-2489, US

(73) Assignee: DISPLAY PACK, INC., Grand Rapids, MI (US)

(21) Appl. No.: 12/234,918

(22) Filed: Sep. 22, 2008

(51) Int. Cl. B65D 43/16; B65D 43/22; B29C 51/26

(52) U.S. Cl. 220/834; 220/825; 220/837; 220/839; 264/241; 264/268; 206/774; 206/459.5

(57) ABSTRACT

A blister package is provided including a blister for holding and dispensing articles. The blister package includes a backing and a blister defining an opening and having an integral, re-closable closure for selectively covering the opening. The closure may include snap elements that can be snap-fitted into notches in the blister for securely retaining the blister in a closed position. Optionally, the closure may joined to the blister by an integral, flexible fastener, which may be a strap and/or a living hinge. A method of packaging an article in a blister package includes: (a) forming a plastic blister, (b) forming an opening in the blister, and (c) forming a closure integral with the blister for covering the opening.

### BACKGROUND OF THE INVENTION

The present invention relates to packaging, and more particularly to blister packages.

A wide variety of products intended for retail sale are packaged in plastic packaging. One of the most common forms of plastic point-of-sale packages is a blister package, which typically includes a plastic blister that forms the front of the package and a backing material, such as paperboard, that closes the blister and seals the product in the package.

Blister packages vary dramatically in design and configuration. However, many take the form of a “face-seal” blister package. A conventional “face-seal” blister package will include a blister that is secured to the face of the backing material by adhesive. This backing material is typically a paperboard panel, but may be manufactured from other materials.

Blister packages are advantageous because they require only a small amount of plastic and are therefore relatively inexpensive to manufacture. However, the blister package construction may suffer from several drawbacks in certain applications. For example, the packaged article is sealed within the blister pocket, between the blister and the backing material, such that the blister typically must be torn from the backing material in order to access the article. Once torn, the blister package cannot be easily resealed.

### SUMMARY OF THE INVENTION

The present invention provides various embodiments of a blister package having a blister that defines an opening and includes an integral, re-closable lid that can be selectively manipulated to expose or cover the opening, thus providing temporary access to the contents of the blister package.

In one embodiment, a blister package includes a backing and a blister that defines an opening and includes an integral closure extending from the blister. The closure is selectively moveable into securing engagement with the blister to partially or fully cover the opening.

In one embodiment, the closure is joined to the blister by an integral fastener, which may be formed as a strap or handle and/or living hinge. The fastener may include at least one bend or pleat to increase the flexibility of the fastener to better allow the lid to be opened and closed. The fastener may extend from a periphery of the blister. The blister, the fastener, and the closure may be thermoformed from a single piece of stock material.

Optionally, the closure may include at least one snap element that corresponds to at least one notch on the blister, such that the snap element may be snap-fitted into the notch to securely retain the closure over the opening. The characteristics of the snap element and/or notch, such as shape and length, may be varied to provide the stiffness desired to retain the snap element in engagement with the notch. Optionally, the closure may seal the opening to prevent leakage of the contents through the opening.

In another embodiment, the closure includes tabs designed to retain a backer card for display purposes. The backer card provides a viewing surface on which information about the product being sold can be provided to the customer.

In yet another embodiment, the blister may include a flange around its periphery. The flange may be adhered to the backing for enclosing an article in the blister package. Optionally, the backing and/or the blister may be provided with an aperture for hanging the blister package from a display hook at point of sale.

In another aspect of the invention, a method is provided for forming a blister package including the steps of: (a) forming a plastic blister, (b) forming an opening in the blister, and (c) forming a closure integral with the blister for covering the opening.

Thus, the present invention provides a blister package having a blister provided with an opening and having an integral, re-closable lid that can be used to selectively open and close the blister. The contents of the blister can be accessed and then re-closed or re-sealed in the blister, which may make the blister package desirable for articles that are used one at a time, such as wipes or cloths. Additionally, because the blister, lid and fastener are integrally formed, the blister is cost effective and relatively easy to manufacture. The one-piece blister, lid and fastener can be formed from a single, one-sided die.

These and other objects, advantages and features of the invention will be more readily understood and appreciated by reference to the detailed description of the invention and the drawings.

### BRIEF DESCRIPTION OF THE DRAWINGS

FIG. 1 is a front perspective view of a blister according to one embodiment of the present invention.

FIG. 2 is an expanded view of the lid of the blister.

FIG. 3 is a top plan view of the blister package.

FIG. 4 is a side view of the blister package.

FIG. 5 is a front view of the blister package.

FIG. 6 is a sectional view of the lid in a closed position.

FIG. 7 is a sectional view of the closure mechanism of the lid.

### DETAILED DESCRIPTION OF THE CURRENT EMBODIMENT

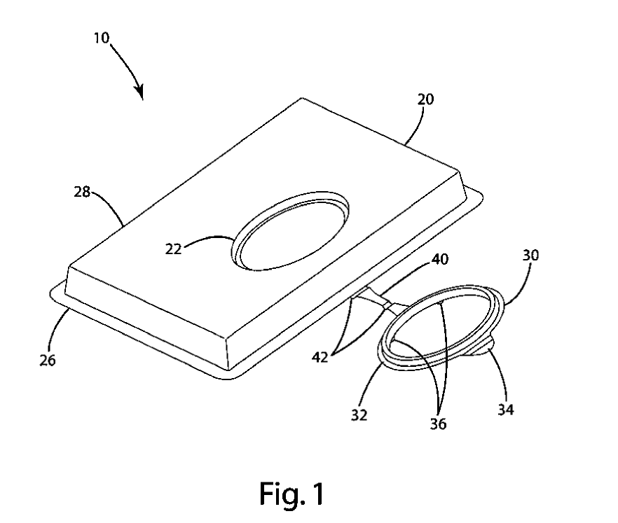

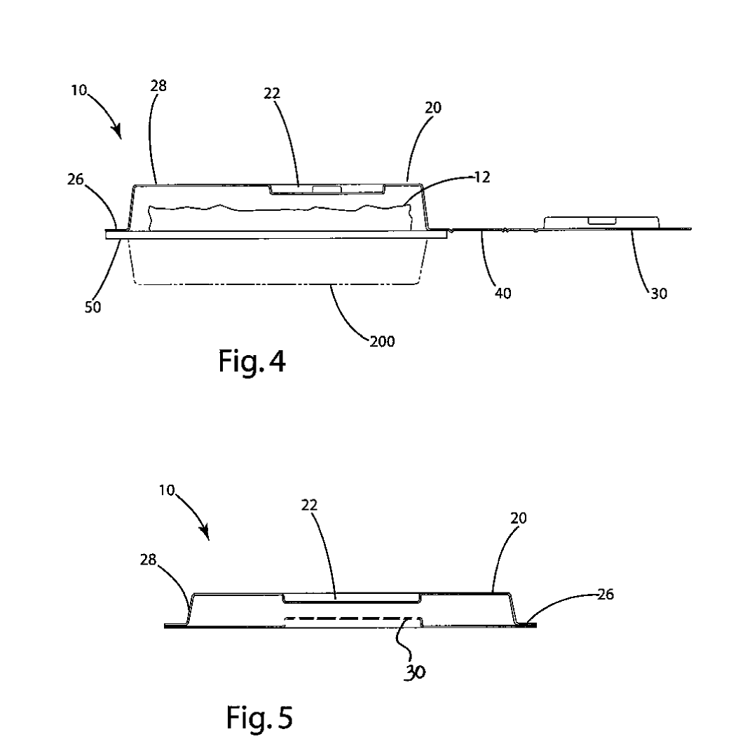

A package in accordance with one embodiment of the invention is shown in FIG. 1, and generally designated 10. The blister package 10 is designed to hold and display articles 12 for sale, and in some embodiments, dispense the articles for use (see FIG. 4). In the illustrated embodiment, the blister package 10 includes a blister 20 and a backing 50. The blister 20 defines an opening 22 from which articles can be dispensed and includes an integral closure or lid 30 that may be unitarily formed with the blister for covering the opening 22.

The blister 20 can be virtually any desired size and shape depending on the article to be packaged and on aesthetic considerations. In the illustrated embodiment, the blister generally defines a pocket or platform recess 28, in which articles can be held (See FIG. 1). In this embodiment, the blister 20 forms a flange 26 extending outwardly around the periphery of the blister. The peripheral flange 26 may facilitate the fastening or adhering of the blister 20 to the backing 50 of the blister package 10, which will be discussed in more detail below.

The blister 20 may be injection molded or thermoformed, and is typically constructed from polyvinyl chloride (PVC) or polyethylene terephthalate (PET) or some other polymer. Although the blister stock is typically transparent or translucent, the stock may be opaque in some applications. The blister 20 will vary in thickness from application to application. For standard applications, the blister 20 is likely to have a thickness ranging between 12 and 30 gauge (i.e. 12 to 30 thousands of an inch).

The opening 22 may be positioned anywhere on the blister and may be selectively sized to accommodate the articles being dispensed from the blister package. For example, the opening 22 may be sized to allow a user to access and remove an article such as a wipe or cloth from the package. The opening 22 may also be positioned to align with a particular feature of the article. In the illustrated embodiment, opening 22 is positioned on a top surface of the blister 20 and is generally oval-shaped.

The lid 30 is formed as an integral part of the blister 20. To allow the lid to be selectively removed from and replaced over the opening 22, the lid 30 may be connected or joined to the blister by an integral and flexible or bendable fastener. In the illustrated embodiment, the fastener is a integral handle or strap 40, which is formed as a narrow strip of material extending from the blister 20. Optionally, the strap 40 may be formed as a living hinge, which is a thin strip molded between the blister 20 and the lid 30 which can flex or bend to allow movement of the lid 30 with respect to the blister 20, with minimal friction and very little wear. Thus, the strap 40 may be designed to allow the lid 30 to be opened and closed over the life of the blister package 10 with little or no loss of function.

Because the strap 40 and lid 30 are formed integrally with the blister 20, all three elements can be injection molded or thermoformed in one piece, such as from a single, one-sided die. The one-piece design eliminates the need for a separate lid and strap and eliminates the extra manufacturing step of attaching the lid and strap to the blister. In addition to reducing production costs, this configuration eliminates or reduces the risk that the lid and/or strap will be removed and misplaced during use.

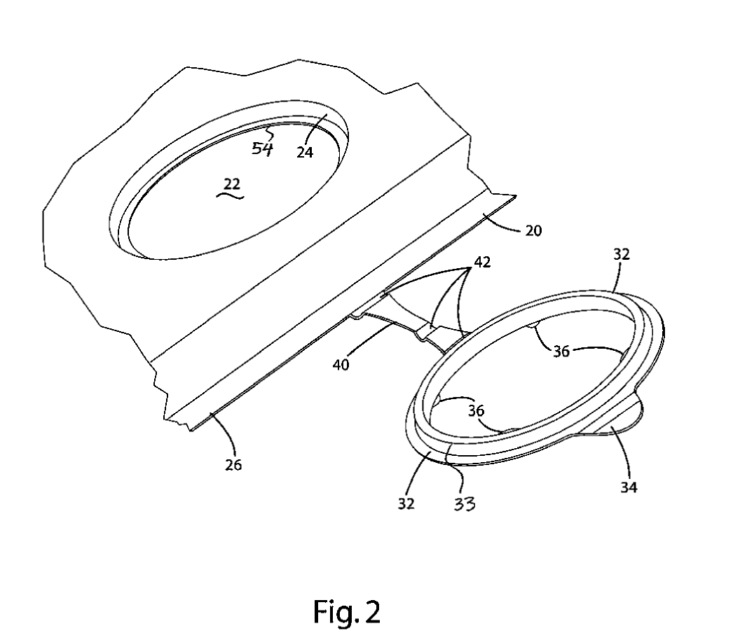

Optionally, and as shown in FIGS. 1 and 2, the strap 40 may include at least one accordion-like bend or pleat 42 to increase the flexibility of the strap. The bends 42 may also increase the strength and/or durability of the strap 40, which may further enable the lid to be repeatedly opened and closed without failure of the strap. As best shown in FIG. 2, the strap 40 includes a bend 42 at or near the point of connection with the blister 20 and at the point of connection with the lid 30. A plurality of bends 42 are also included along the strap 40 between the blister 20 and the lid 40. These bends may be selectively positioned to allow for extra bending or flexing at the point at which the strap contacts and bends over an edge of the blister 20 to allow the lid 30 to close. The bends 42 may be facilitated by trim lines, die cuts, or other mechanisms generally know in the art.

In the illustrated embodiment, the strap 40 and lid 30 extend from the periphery of the blister and, in particular, from the edge of the flange 26. However, the strap 40 may alternately extend from a top or side surface of the blister, or from any surface allowing the lid to be removed from and replaced over the opening 22.

The integral lid 30 may be selectively sized and shaped to partially or fully cover the opening 22. In the illustrated embodiment, the lid 30 is generally oval and generally corresponds with the shape of opening 22, such that the lid is adapted to completely cover the opening. The lid 30 may be closed and secured to the blister 20 using any suitable closure mechanism or retainer or fastener or the like. In the illustrated embodiment, the lid 30 includes a seal portion 33, formed as an extension or protrusion at or near the periphery of the lid. The blister 20 forms a shelf or ledge 54 at the periphery of the opening 22 for receiving the seal portion 33 of the lid 30 (see FIGS. 2, 6 and 7). As shown in FIGS. 5 and 7, the depth of the ledge 54 generally corresponds with the depth of the seal portion 33. The seal portion 33 may formed or sized to provide a friction fit, such that the lid 30 is retained at or over the opening 22.

Alternately, or additionally, the lid 30 may be snap-fitted to the blister 20 at the opening 30. In the illustrated embodiment, the lid 30 includes two snap elements 32 positioned on the seal portion 33 of the lid 30 (see FIG. 7). The snap elements 32 are adapted to engage corresponding notches 24 formed on the ledge 54 of the blister 20. In the illustrated embodiment, the snap elements 32 are positioned at opposite ends of the lid 30 and are formed as protrusions or projections from the outer radial surface of the seal portion 33 of the lid 30. The snap elements 32 are adapted to be pressed or snapped into the notches 24 of the blister, such that the lid 30 is securely retained in the closed position. The characteristics of the snap elements 32, such as the shape and/or length of the snap elements, may be varied to provide the stiffness desired to maintain a snap-fit between the snap elements 32 and the notches 24. For example, longer snap elements 32 may reduce the overall force required to snap-fit the lid 30 in place. The leading closing edge of the snap element 32 may be non-planar to provide less resistance when snapping the snap element 32 into engagement with the notch 24. Alternatively, or additionally, the characteristics of the notch, such as size or shape, may be varied to control the force required to operate the snap-fitting interaction of the snap elements 32 and notches 24.

Optionally, the seal portion 33 of the lid 30 may be adapted to positively seal the opening 22 to prevent leakage of the contents of the blister package 10 through the opening, such that the blister package 10 is capable of holding liquid or moistened contents or articles, such as moistened cloths or wipes. In such an embodiment, an O-ring or seal may optionally be included on the seal portion 33 of the lid 30 or on the ledge 54 of the blister 20 (not shown). Alternatively, the lid 30 may be formed to partially cover the opening, such that the contents of the blister package 10 are partially exposed even when the lid 30 is closed, to allow prospective purchasers to touch or otherwise access the contents prior to purchasing.

Optionally, the lid 30 may include a grip 34 to facilitate the opening of the lid. In the illustrated embodiment, the grip 34 is formed as a thin tab extending from the periphery of the lid and positioned on an opposite side of the lid from strap 40. A user can grasp and pull the grip 34 to disengage the snap elements 32 from the notches 24 to open the lid.

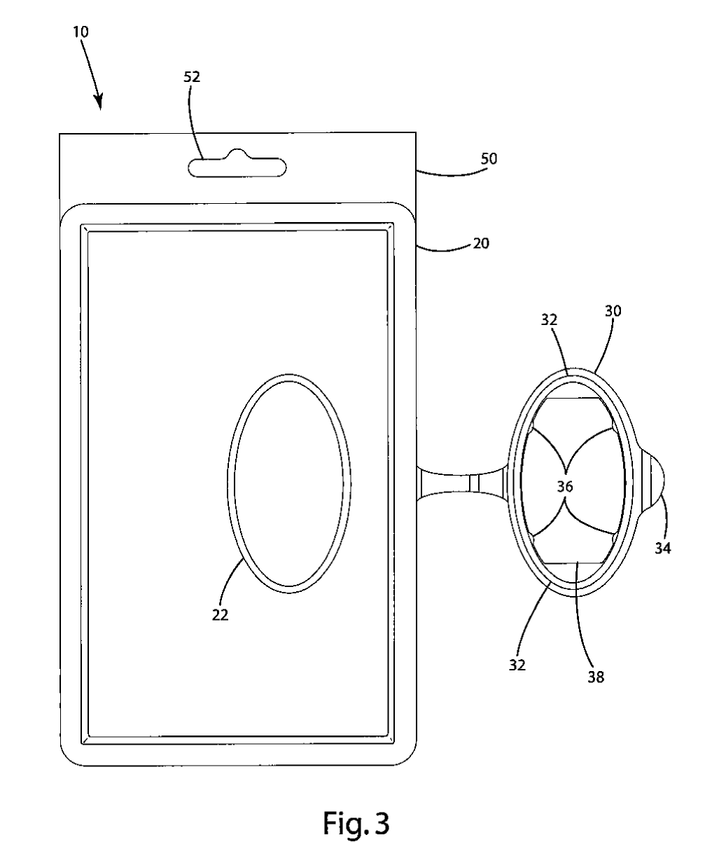

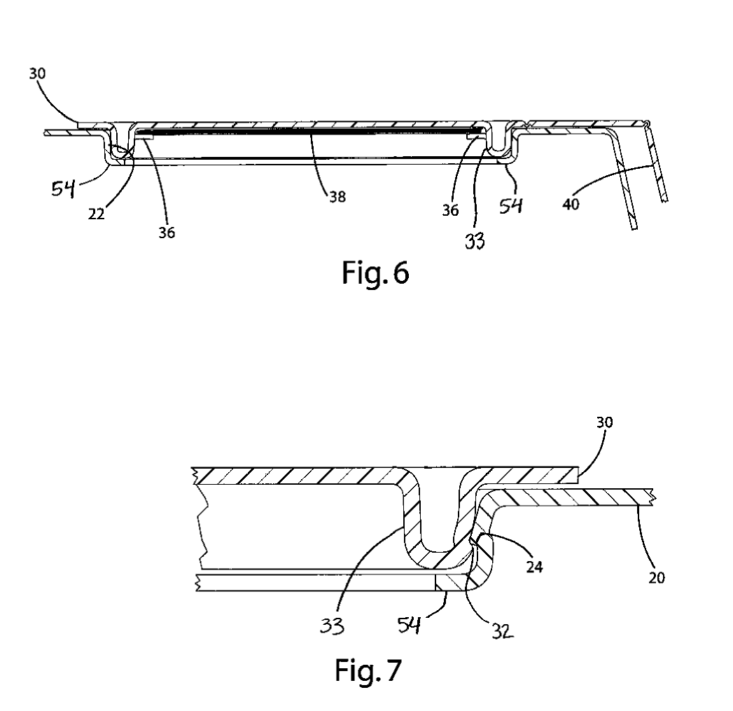

Optionally, the lid 30 may be adapted to retain a backer card 38, such as an informational card regarding the contents or articles in the blister package 10 (see FIGS. 3 and 6). In the illustrated embodiment, the lid 30 includes four tabs 36 extending from an inner radial surface of the seal portion 33 of the lid 30. The four tabs 46 are spread out generally equidistant across the circumference of the lid. The tabs 36 may be formed as clips or hooks or any structure adapted to contact and retain the backer card 38 in position on the lid. The backer card 38 may be dimensioned such that a surface of the backer card 38 maintains contact with the tabs 36. Typically, the backer card 38 is constructed out of paperboard material. However, other materials commonly known in the art, such as plastic, may also be used.

In the illustrated embodiment, the tabs 36 retain the backer card 38 at an inner surface of the lid. In such an embodiment, the lid 30 is formed from a transparent or translucent material, such that the backer card 38 viewable through the lid when the lid is closed. In this embodiment, the backer card 38 provides front and rear viewing surfaces on which product information and other graphics can be displayed. Alternatively, the tabs 36 may extend from an outer surface of the lid 30, to retain the backer card 38 outside of the blister package 10. This configuration may be desirable if the lid is formed from an opaque material, to enable the backer card 38 to be viewed when the lid 30 is closed.

The backing 50 of the blister package 10 can be any desired size and shape depending on the dimensions of the blister 20 and on the article to be packaged. In the illustrated embodiment, the backing 50 is formed as a rear wall that may be adhered and/or sealed against the blister 20 (See FIGS. 3 and 4). In the illustrated embodiment, the flange 26 of the blister is adhered to the face of the backing 50 using an adhesive known in the art. However, any suitable connector or fastener may be used to join the backing 50 to the blister 20. The backing 50 is typically constructed out of paperboard material. However, other materials commonly known in the art, such as plastic, may also be used.

Optionally, the backing 50 may form a pocket or platform recess 200, such as a platform recess that mirrors the shape of the blister 20 (See FIG. 4). Such a backing creates a blister package 10 having a greater volume, such that the blister package may hold more contents or articles. Such a platform recess may be formed from paperboard material or plastic, as desired.

Optionally, the backing 50 and/or the blister 20 defines a hole 52 for hanging the blister package 10 from a display hook at a point of sale as shown in FIG. 3. The size, shape and location of this hanging hole 52 will vary depending on the article offered for sale.

In another aspect, the present invention provides a method for forming a blister package, such as blister package 10 described above. The method includes the steps of: (a) forming a plastic blister, (b) forming an opening in the blister, and (c) forming a closure integral with the blister for covering the opening. The blister and closure of the method may be substantially similar to blister 20 and lid 30 described above.

In one embodiment, the blister is formed by placing sheet stock in a mold and thermoforming the blister. The forming step may include forming an integral, flexible fastener, such as strap 40 described above, to join the blister and the closure. Because the fastener and closure are formed integrally with the blister, all three elements can be thermoformed in one piece, by placing a single sheet of stock material in the mold or die cavity.

Optionally, a peripheral flange may be formed about the periphery of the blister. The integral fastener may then be formed to extend from an edge of the peripheral flange. In one embodiment, a backing may be attached to the peripheral flange to close the blister package.

Optionally, the blister may be formed with at least one notch, and the closure may be formed with at least one snap element adapted to fit in the notch. The snap element may be sized and/or shaped to snap-fit into the notch to selectively secure the closure over the opening, as discussed above with respect to notches 24 and snap elements 32.

In one embodiment, the closure may be formed with at least one tab, such as tabs 36 described above, for holding a backer card. The tabs may be formed as projections extending from an inner radial surface of the closure, such that they can hold or clip a backer card against the closure.

The above description is that of the current embodiment of the invention. Various alterations and changes can be made without departing from the spirit and broader aspects of the invention as defined in the appended claims, which are to be interpreted in accordance with the principles of patent law including the doctrine of equivalents.

1. A blister package for packaging an article comprising:
a blister, said blister defining an opening;
an integral closure extending from said blister, wherein said closure is selectively moveable into securing engagement with said blister to at least partially cover said opening; and
a backing attached to said blister.

2. The blister package of claim 1, wherein said closure is joined to said blister by an integral fastener.

3. The blister package of claim 2, wherein said fastener is a living hinge.

4. The blister package of claim 2 wherein said fastener includes at least one bend.

5. The blister package of claim 2, wherein said blister includes a peripheral flange, wherein said fastener extends from said peripheral flange.

6. The blister package of claim 5, wherein said backing is adhered to said peripheral flange.

7. The blister package of claim 2, wherein said blister, said fastener and said closure are thermoformed from a single piece of stock material.

8. The blister package of claim 1, wherein said closure includes at least one snap element and wherein said blister includes at least one notch, wherein said snap element is adapted to be snap-fitted into said notch for retaining said closure over said opening.

9. The blister package of claim 8, wherein said closure includes a seal portion adapted to seal said opening.

10. The blister package of claim 1, wherein said closure includes at least one tab adapted to retain a backer card.

11. The blister package of claim 1, wherein at least one of said backing and said blister contains a hanging aperture.

12. A method for forming a blister package comprising the steps of:
forming a plastic blister;
forming an opening in the blister; and
forming a closure integral with the blister, wherein said closure is adapted to cover the opening.

13. The method of claim 12, wherein said forming a plastic blister step includes placing sheet stock in a mold and thermoforming the blister.

14. The method of claim 13, further comprising forming an integral fastener to join the blister and the closure.

15. The method of claim 14, wherein said forming a plastic blister step includes forming a peripheral flange about the periphery of the blister.

16. The method of claim 15, wherein said forming an integral fastener step includes forming the fastener to extend from the peripheral flange.

17. The method of claim 16, further comprising attaching a backing to the peripheral flange.

18. The method of claim 17, further comprising forming the blister with at least one notch and forming the closure with at least one snap element adapted to fit in the notch.

19. The method of claim 17, further comprising forming the closure with a seal portion for sealing the opening in the blister.

20. The method of claim 19, further comprising forming the closure with at least one tab for holding a backer card.
